(19) United States
(12) Patent Application Publication
(10) Pub. No.: US 2026/0203653 A1
(43) Pub. Date: Jul. 16, 2026

(54) A system and method for mitigating data noise in a training data set used to train a machine-learning model

(71) Applicant: Bank of America Corporation, Charlotte, NC (US)

(72) Inventors: Sivashalini Sivajothi, Chennai (IN); Maneesh Kumar Sethia, Hyderabad (IN); Abhijit Behera, Hyderabad (IN); Kunta Dilip, Hyderabad (IN); Srinivas Borra, Hyderabad (IN); Banda Madhu Sekhar, Hyderabad (IN)

(21) Appl. No.: 19/025,366

(22) Filed: Jan. 16, 2025

(51) Int. Cl. G06N 20/00

(52) U.S. Cl. CPC G06N 20/00

(57) ABSTRACT

A first training data to be used to train a first artificial intelligence (AI) algorithm associated with a first AI model is input to a second AI model trained to determine noise in the first training data. Based on one or more performance metrics determined based on the first training data, the second AI model determines that the first training data includes a first type of noise. A first noise mitigation algorithm associated with the identified first type of noise is identified and run to mitigate the first type of noise in the first training data and generate first clean training data. The AI algorithm of the first AI model is then trained based on the first clean training data.

### TECHNICAL FIELD

The present disclosure relates generally to machine learning, and more specifically to a system and method for mitigating data noise in a training data set used to train an artificial intelligence (AI) algorithm/machine-learning (ML) algorithm associated with an AI/ML model.

### BACKGROUND

Often, training data used to train an artificial intelligence (AI) algorithm/machine-learning (ML) algorithm associated with an AI/ML model consists of noise. Noise in training data refers to any irrelevant or misleading information that can distort the AI/ML model’s learning process. Noise in training data can significantly affect the performance and generalization ability of an AI/ML model by making it harder for the AI/ML model to discern the underlying patterns in the training data. The presence of noise in training data can lead to poor predictions, overfitting, and increased computational complexity.

### SUMMARY

The system and method implemented by the system as disclosed in the present disclosure provide technical solutions to the technical problems discussed above by proactively detecting and mitigating noise in training data to be used to train an artificial intelligence (AI)/machine-learning (ML) algorithm associated with an AI/ML model.

Noise in training data used to train an AI algorithm refers to any irrelevant or misleading information that can distort the AI algorithm’s learning process. Noise can originate from various sources during the data collection, processing, or labeling stages. Training data may include one or more of several types of noise including, but not limited to, label noise, feature noise, sampling noise, random noise, outliers, concept drift noise, media noise (noise relating to media such as pictures, audio, video etc.).

Noise in training data can significantly affect the performance and generalization ability of an AI model by making it harder for the AI model to discern the underlying patterns in the training data. The presence of noise in training data can lead to poor predictions, overfitting, and increased computational complexity. Overfitting occurs when noise in training data causes the AI model to learn the noisy data rather than learning the true underlying patterns. This results in overfitting, where the AI model performs well on training data but poorly on unseen data due to its lack of generalization. For example, due to noise in the training data, the AI model may learn spurious correlations in data that are not present in real-world data. In some cases, the AI model may struggle to generalize to new, unseen data because the model has learned from noisy patterns in training data that do not reflect the true distribution of the problem. This reduces the AI model's effectiveness in practical applications. In some cases, noise in training data may lead to increase model complexity of an AI model. For example, noise can force the AI model to learn more complex, unnecessary features or relationships to account for the irregularities, leading to an increase in model complexity.

Thus, noise in training data can cause the AI model to generate incorrect results. For example, presence of noise in training data reduces the accuracy of the AI model because it makes it harder for the learning algorithm to differentiate between useful and irrelevant information. Noise can introduce biases in the model’s predictions, especially if the noise disproportionately affects certain subsets of the data. In addition to compromising the performance of the AI model, noise fed into an AI model during training can significantly affect both the performance of the underlying computer and network systems by causing increased training and inference times, increased computational load, increased risk of hardware overload, increased data traffic, increased latency, and reduced model performance over the network. For example, noise in training data increases the variability in the data, requiring the model to process and "filter out" irrelevant information during training. As a result, the model may need more iterations to learn meaningful patterns, thus extending the overall training time. This increases computational load on computing systems carrying out the training of the AI algorithm and reduces throughput and overall performance and these computing systems. Further, noise often requires additional processing, such as filtering, cleaning, or handling missing values, which increases the computational resources required (CPU, memory, storage). The presence of noise may necessitate more complex algorithms, such as more advanced regularization methods or ensemble approaches, further increasing the computational demands. As the model may need to handle more features or maintain more complex structures (e.g., deep decision trees or larger neural networks) to account for noise, this leads to increased memory usage. For example, large neural networks trained on noisy data can result in models that are not only harder to train but also more memory-intensive during inference.

In systems with limited computational resources, the increased computational load due to processing noisy data can overload hardware. This might result in system crashes, timeouts, or resource throttling. For example, training a complex model like a deep neural network with noisy data on a GPU can cause overheating or resource saturation, especially if the model is trying to process a large amount of noisy data in a short period.

Conventional systems have limitations when it comes to detecting and mitigating noise in training data used to train machine learning models. These limitations can affect the model's accuracy, generalization, and overall performance. Conventional systems often rely on simple statistical methods or heuristics to identify noisy data. For instance, they might filter out extreme outliers or points that fall outside a predefined range, but they lack the ability to understand the context or relationships between data points. This means that subtle forms of noise (e.g., mislabeled data or context-specific errors) might go undetected. In addition, conventional systems often rely on manual preprocessing and domain-specific knowledge to identify and clean noisy data. This is time-consuming and error-prone. Domain experts may need to manually label or flag noisy data, and this process can lead to inconsistent results, especially in large datasets. As the size of the dataset grows, the manual effort required to inspect and clean noisy data becomes infeasible. For large-scale datasets, conventional methods struggle to scale, and human involvement becomes a bottleneck.

Embodiments of the present disclosure provide several practical applications and technical advantages that provide solutions to the problems discussed above in relation to conventional computing systems and networks.

For example, the disclosed system and methods provide the practical application of accurately detecting noise in training data and effectively mitigating (e.g., lowering and/or removing) the detected noise from the training data. As described in embodiments of the present disclosure, to detect noise in first training data to be used to train a first AI algorithm associated with a first AI model, a training manager employs a second AI model that is trained to detect several types of noise in training data used to train AI algorithm and further to determine a noise mitigation algorithm that can be used to mitigate the detected noise. In one or more embodiments, a second AI algorithm associated with the second AI model is trained based on known noise patterns associated with several noise types and corresponding performance metrics known to be associated with the noise patterns, to detect whether first training data includes noise and further to determine what noise type is included in the first training data. Each known noise pattern is a general pattern of noise data known to be associated with a particular noise type and is identified by one or more performance metrics associated with the training data being analyzed by the second AI model. A performance metric indicates quality of the training data based on which the performance metric was determined.

The second AI algorithm is trained to identify a particular noise pattern of a particular noise type in the first training data based on a score assigned to one or more performance metrics. The assumption here is that a particular noise pattern that represents a particular noise type causes one or more performance metrics to achieve certain scores. For example, a noise pattern that represents label noise may cause a score of the label consistency metric to be lower than a predefined threshold defined for the label consistency metric, thus indicating that the first training data includes label noise.

In operation, training manager inputs the first training data to the trained second AI model and executes the trained second AI algorithm associated with the second AI model causing the second AI model to analyze the first training data and determine a plurality of performance metrics and corresponding scores based on the first training data. Once the performance metrics have been determined/obtained, the second AI model maps the determined performance metrics and respective scores with known noise patterns of various noise types based on known associations between the performance metrics and known noise patterns. Upon determining a matching noise pattern, the second AI model determines that the first training data includes noise of a particular noise type that corresponds to the matching noise pattern. Once it is determined that first training data includes noise of a particular noise type, second AI model determines an appropriate noise mitigation algorithm that can be used to mitigate (e.g., lower/remove) the detected noise from the first training data and runs the noise mitigation algorithm to lower/remove the detected noise from the training data and generate clean training data. The clean training data is then used to train the first AI algorithm associated with the first AI model.

Removing noise from training data plays a crucial role in improving the performance of machine learning models and the underlying computational systems (including both the computer and network). By cleaning the training data, the AI model can focus on learning meaningful patterns, improving its ability to generalize to new, unseen instances. Models trained on clean data are more likely to make accurate predictions because they have learned from data that reflects true relationships and not outliers or mislabeled points. This results in higher predictive accuracy. This improves the speed of training the AI algorithm as well predictions during inference, which in turn improves processing efficiency and throughput of the underlying computing systems and network.

For example, by removing noisy or irrelevant data, the disclosed system and method reduce the memory and storage requirements for both training and serving the model, which makes better use of the available hardware. In addition, removing noise from the training data reduces the number of operations needed during training, leading to faster training times and more efficient use of the computational resources (CPU, GPU, etc.). When training a model in a distributed environment or across a network (e.g., cloud-based training or federated learning), large noisy datasets increase the amount of data that must be transmitted across the network. Cleaning the data reduces the bandwidth required for communication between nodes, thus improving network efficiency and reducing delays. Further, by ensuring the model is trained on clean data, it becomes more efficient at making predictions and requires less computational effort at inference time.

Thus, the disclosed system and method generally improve the technology associated machine-learning and artificial intelligence systems.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure; and

FIG. 2 illustrates a flowchart of an example method for detecting and mitigating noise in training data, in accordance with certain embodiments of the present disclosure.

### DETAILED DESCRIPTION

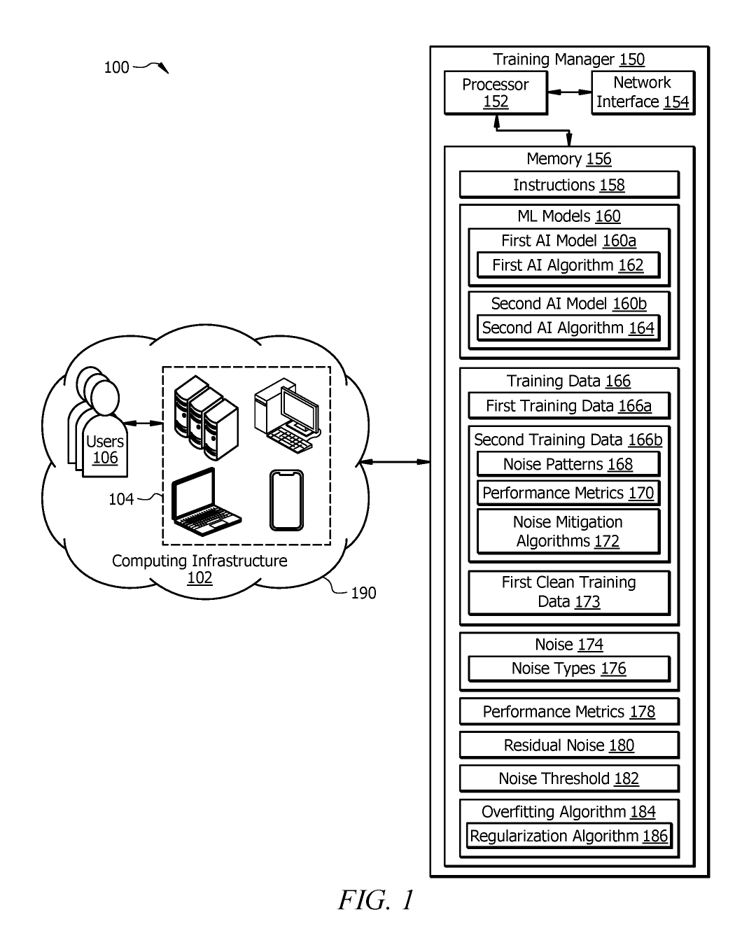

FIG. 1 is a schematic diagram of a system 100, in accordance with certain aspects of the present disclosure. As shown, system 100 includes a computing infrastructure 102 connected to a network 190. Computing infrastructure 102 may include a plurality of hardware and software components. The hardware components may include, but are not limited to, computing nodes 104 such as desktop computers, smartphones, tablet computers, laptop computers, data servers and data centers, mainframe computers, virtual reality (VR) headsets, augmented reality (AR) glasses and other hardware devices such as printers, routers, hubs, switches, and memory all connected to the network 190. Software components may include software applications that are run by one or more of the computing nodes 104 including, but not limited to, operating systems, user interface applications, third party software, database management software, service management software, mainframe software, metaverse software, AI tools and other customized software programs (e.g., training manager 150) implementing particular functionalities. For example, software code relating to one or more software applications may be stored in a memory device and one or more processors (e.g., belonging to one or more computing nodes 104) may execute the software code to implement respective functionalities. An example software application run by one or more computing nodes 104 of the computing infrastructure 102 may include the training manager 150. In one embodiment, at least a portion of the computing infrastructure 102 may be representative of an Information Technology (IT) infrastructure of an organization.

One or more of the computing nodes 104 may be operated by a user 106. In this context, a computing node 104 operated by a user may be referred to as a user device. For example, a computing node 104 may provide a user interface using which a user 106 may operate the computing node 104 to perform data interactions within the computing infrastructure 102. The term “computing node 104” may be replaced by “user device” in this disclosure when the computing node 104 is operated by a user 106.

One or more computing nodes 104 of the computing infrastructure 102 may be representative of a computing system which hosts software applications that may be installed and run locally or may be used to access software applications running on a server. The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server running one or more software applications to implement respective functionality as described below. In certain embodiments, one or more of the computing nodes 104 may run a thin client software application where the processing is directed by the thin client but largely performed by a central entity such as a server (not shown).

Network 190, in general, may be a wide area network (WAN), a personal area network (PAN), a cellular network, or any other technology that allows devices to communicate electronically with other devices. In one or more embodiments, network 190 may be the Internet.

An artificial intelligence (AI) model (e.g., AI models 160 shown in FIG. 1) is a mathematical framework that learns patterns from data in order to make predictions or decisions without being explicitly programmed for every task. The model is designed to recognize relationships or patterns within the input data (features) and use this learned information to make predictions on new, unseen data. The core idea is that the AI model "learns" from historical data (training data) and generalizes that learning to make accurate predictions on test data or real-world applications. Depending on the task, AI models can be classified into several categories. For example, an AI algorithm associated with a supervised AI model is trained on labeled data (e.g., inputs paired with known outputs) to learn the mapping between inputs and outputs. An AI algorithm associated with an unsupervised AI learning model is trained on unlabeled data to find hidden patterns or groupings (e.g., clustering or dimensionality reduction). A reinforcement AI model learns by interacting with an environment and receiving feedback based on actions taken.

AI models 160 rely on various AI algorithms (e.g., first AI algorithm 162, second AI algorithm 164) to learn from data (e.g., training data 166) and make predictions, classifications, or decisions. The choice of algorithm depends on the type of task (supervised, unsupervised, reinforcement learning), the nature of the data, and the specific problem being solved. Common AI algorithms used by AI models include, but are not limited to, supervised learning algorithms such as regression and classification algorithms, unsupervised learning algorithms such as clustering algorithms and dimensionality reduction algorithms, reinforcement learning algorithms, ensemble learning algorithms, and deep learning algorithms. As shown in FIG. 1, first AI model 160a uses first AI algorithm 162 and second AI model 160b uses second AI algorithm 164.

Often, training data 166 used to train an AI model 160 consists of noise 174. Noise 174 in training data 166 in the context of the present disclosure refers to any irrelevant or misleading information (e.g., anomalies) that can distort the AI model's learning process. Noise 174 can originate from various sources during the data collection, processing, or labeling stages. Training data 166 may include one or more of several types of noise 174 (e.g., noise types 176 shown in FIG. 1). For example, noise types 176 may include, but are not limited to, label noise, feature noise, sampling noise, random noise, outliers, concept drift noise, media noise (noise relating to media such as pictures, audio, video etc.). Label noise occurs when labels in training data 166 are incorrect or inconsistent. Examples of label noise include mislabeling of categories in a classification task (e.g., labeling a cat as a dog), and inconsistent or ambiguous labeling due to human error or system malfunctions. Feature noise includes incorrect or irrelevant values in the feature set of the training data 166 that do not reflect the true underlying distribution of the data. Examples of feature noise include sensor errors or faulty measurements in real-world data collection and missing or imputed data values that do not reflect the true distribution. Sampling noise generally results from insufficient or unrepresentative sampling of the data, which can lead to over-representation or under-representation of certain patterns. An example of sampling noise includes data collected from only a specific region or demographic that doesn't generalize to the broader population. Random noise (e.g., including media noise) is generally introduced by random variations or fluctuations in the data that have no meaningful relationship to the underlying signal. An example of random noise includes small, uncorrelated fluctuations in time-series data or image pixels. Outliers are extreme or anomalous data points in training data that deviate significantly from the rest of the training dataset. An example or an outlier noise includes a house price data point that is 100 times higher than the others due to a data entry error. Concept drift is a dynamic type of noise where the data distribution changes over time, which can lead to a misalignment between the training data and the real-world environment. An example of concept drift includes changes in consumer behavior over time, altering the relevance of certain features in a predictive model.

Noise 174 in training data 166 can significantly affect the performance and generalization ability of an AI model 160 by making it harder for the AI model 160 to discern the underlying patterns in the training data 166. The presence of noise 174 in training data 166 can lead to erroneous results (e.g., poor predictions), overfitting, and increased computational complexity. Overfitting occurs when noise 174 in training data 166 causes the AI model 160 to learn the noisy data rather than learning the true underlying patterns. This results in overfitting, where the AI model 160 performs well on training data 166 but poorly on unseen data due to its lack of generalization. For example, due to noise 174 in the training data 166, the AI model 160 may learn spurious correlations in data that are not present in real-world data. In some cases, the AI model 160 may struggle to generalize to new, unseen data because the model has learned from noisy patterns in training data 166 that do not reflect the true distribution of the problem. This reduces the AI model's effectiveness in practical applications. In some cases, noise 174 in training data 166 may lead to increase model complexity of an AI model 160. For example, noise 174 can force the AI model 160 to learn more complex, unnecessary features or relationships to account for the irregularities, leading to an increase in model complexity.

Thus, noise 174 in training data 166 can cause the AI model 160 to generate incorrect results. For example, presence of noise 174 in training data 166 reduces the accuracy of the AI model 160 because it makes it harder for the learning algorithm to differentiate between useful and irrelevant information. Noise 174 can introduce biases in the model’s predictions, especially if the noise disproportionately affects certain subsets of the data. In addition to compromising the performance of the AI model 160, noise 174 fed into an AI model 160 during training can significantly affect both the performance of the underlying computer and network systems by causing increased training and inference times, increased computational load, increased risk of hardware overload, increased data traffic, increased latency, and reduced model performance over the network. Conventional systems are incapable of accurately detecting and mitigating noise 174 in training data 166 used to train AI models 160.

Embodiments of the present disclosure provide technical solutions to the technical problems noted above by providing techniques for detecting and mitigating noise 174 in training data 166 used to train AI algorithms associated with AI models 160.

At least a portion of the computing infrastructure 102 (e.g., one or more computing nodes 104) may implement a training manager 150 which may be configured to implement techniques for proactively detecting and mitigating noise 174 in training data 166 to be used to train an AI algorithm associated with an AI model 160. The training manager 150 includes a processor 152, a memory 156, and a network interface 154. The training manager 150 may be configured as shown in FIG. 1 or in any other suitable configuration.

The processor 152 includes one or more processors operably coupled to the memory 156. The processor 152 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

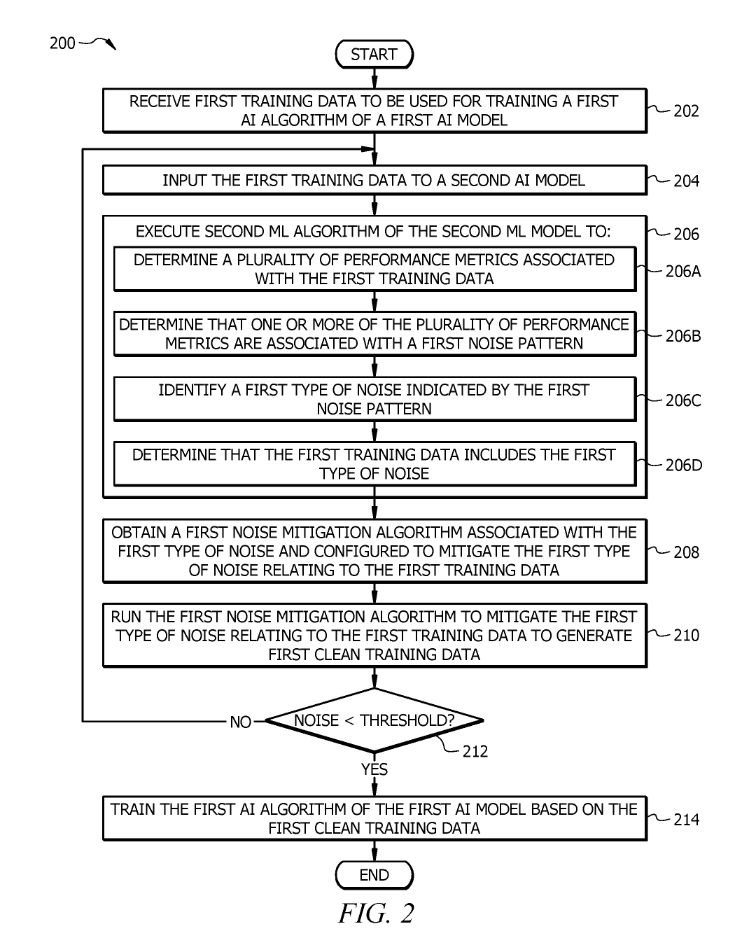

The one or more processors are configured to implement various instructions, such as software instructions. For example, the one or more processors are configured to execute instructions 158 to implement the training manager 150. In this way, processor 152 may be a special-purpose computer designed to implement the functions disclosed herein. In one or more embodiments, the training manager 150 is implemented using logic units, FPGAs, ASICs, DSPs, or any other suitable hardware. The training manager 150 is configured to operate as described with reference to FIGS. 1 and 2. For example, the processor 152 may be configured to perform at least a portion of method 200 as described with reference to FIG. 2 respectively.

The memory 156 includes a non-transitory computer-readable medium such as one or more disks, tape drives, or solid-state drives, and may be used as an over-flow data storage device, to store programs when such programs are selected for execution, and to store instructions and data that are read during program execution. The memory 156 may be volatile or non-volatile and may include a read-only memory (ROM), random-access memory (RAM), ternary content-addressable memory (TCAM), dynamic random-access memory (DRAM), and static random-access memory (SRAM).

The memory 156 is operable to store the instructions 158, AI models 160 such as first AI model 160a and second AI model 160b including AI algorithms such as first AI algorithms 162 and second AI algorithm 164 respectively, training data 166, noise 174 in training data 166, performance metrics 178, residual noise 180, noise threshold 182, overfitting algorithm 184, and any other data needed to performed operations of the training manager 150 as described in embodiments of the present disclosure. The instructions 158 may include any suitable set of instructions, logic, rules, or code operable to execute the training manager 150.

The network interface 154 is configured to enable wired and/or wireless communications. The network interface 154 is configured to communicate data between the training manager 150 and other devices, systems, or domains (e.g., computing nodes 104). For example, the network interface 154 may include a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

It may be noted that each of the computing nodes 104 may be implemented like the training manager 150 shown in FIG. 1. For example, each of the computing nodes 104 may have a respective processor and a memory that stores data and instructions to perform a respective functionality of the computing node 104.

The training manager 150 may be configured to proactively detect and mitigate noise 174 in training data 166 to be used to train an AI algorithm 162, 164 associated with an AI model 160. For example, training manager 150 may be configured to detect and mitigate noise 174 in first training data 166a that is to be used to train the first AI algorithm 162 of the first AI model 160a. While embodiments of the present disclosure are described in the context of detecting and mitigating noise 174 in first training data 166a that is to be used to train the first AI algorithm 162 of the first AI model 160a, these embodiments apply to detecting noise 174 in any training data 166 used to train any AI algorithm associated with any AI model 160. In one embodiment, to detect noise 174 in the first training data 166a, the training manager 150 employs second AI model 160b that is trained to detect several types of noise 174 (e.g., noise types 176) in training data 166 used to train AI algorithms 162, 164 associated with AI models 160 and further to determine a noise mitigation algorithm 172 that can be used to mitigate the detected noise 174. In one or more embodiments, the second AI algorithm 164 of the second AI model 160b is trained based on known noise patterns 168 associated with several noise types 176 and corresponding performance metrics 170 known to be associated with the noise patterns 168, to detect whether first training data 166 includes noise 174 and further to determine what noise type 176 is included in the first training data 166.

While embodiments of the present disclosure are described with reference to AI models and corresponding AI algorithms, it may be noted that these embodiments apply to ML models and corresponding ML algorithms which are a subset of AI models and AI algorithms, respectively.

For example, each known noise pattern 168 is a general pattern of noise data known to be associated with a particular noise type 176 and is identified by one or more performance metrics 170 associated with the training data 166 being analyzed by the second AI model 160b. A performance metric 170 indicates quality of the training data 166 based on which the performance metric 170 was determined. Several performance metrics 170 may be used to identify the type of noise (e.g., noise type 176) and amount of noise in training data 166, wherein the plurality of performance metrics 170 may include, but are not limited to, signal-to-noise ratio (SNR), mean absolute error (MAE), outlier detection metrics, noise-to-data ratio (NDR), class imbalance metrics, label consistency, entropy and variance, or feature correlation matrix. Signal-to-noise ratio (SNR) is a measure that compares the level of meaningful data (signal) to the level of noise 174. A high SNR means that the data has a strong underlying signal with minimal noise 174, while a low SNR indicates a lot of noise 174 relative to the useful information. Mean Absolute Error (MAE)/Root Mean Squared Error (RMSE) are metrics used to quantify the error between predicted values and actual values. A high MAE or RMSE can indicate noise 174 in the data. Outlier Detection Metrics may indicate outliers in training data 166. Outliers are extreme or rare data points that deviate significantly from the rest of the training dataset. Outlier noise can distort model performance, and detecting it is crucial for noise removal. Noise-to-Data Ratio (NDR) is a metric that evaluates the proportion of noise 174 to the overall training data 166. High NDR suggests that the data is overwhelmed by noise 174, while low NDR indicates that the signal is clear. Class Imbalance Metrics may indicate label noise. Label noise is often related to class imbalance, where certain classes are underrepresented or overrepresented in a dataset, leading to incorrect or inconsistent labeling. Class imbalance metrics may include class distribution metric indicating the proportion of samples in each class and class frequency metric indicating the frequency or count of data points for each class in the training dataset.

Label consistency metric may indicate label noise. For example, checking for label consistency involves evaluating whether the labels in the dataset are consistent and correct across similar or duplicate instances. For example, if two identical data points have different labels, this suggests label noise. Entropy metric measures the unpredictability or randomness of the data. High entropy indicates noisy or uncertain data, while low entropy suggests predictable and well-structured data. Variance metric measures the spread of values in the data. High variance can indicate that the data contains a lot of noise, especially if the feature values don’t have clear patterns. Feature correlation metric may indicate feature noise. Feature noise can arise from irrelevant or redundant features. A correlating matrix may identify features that are highly correlated with each other (multicollinearity), which could indicate redundant information.

In one or more embodiments, training manager 150 may be configured to analyze the first training data 166a and determine a plurality of performance metrics 170 based on the first training data 166a. This may include determining a score for each performance metric 170 of the plurality of performance metrics 170, wherein a score associated with a particular performance metric 170 indicates one or more of whether the first training data 166a includes noise 174, an amount of noise 174, or the noise type 176 of the noise 174. For example, an SNR score associated with the SNR metric that is lower than a pre-configured SNR threshold indicates presence of noise 174 in the first training data 166a. Additionally, a lower SNR score indicates higher amount of noise relative to useful information. In another example, when a score associated with the label consistency metric is lower than a threshold score, it indicates presence of label noise in the first training data 166a. In yet another example, when a score of the feature correlation metric equals or exceeds a threshold, it indicates a high correlation between features of the first training data 166a which in turn indicates feature noise in the first training data 166a. In one embodiment, the second AI algorithm 164 of the second AI model 160b may be trained to determine the plurality of performance metrics 170 based on first training data 166a.

The second AI algorithm 164 of the second AI model 160b may be trained to identify a particular noise pattern 168 of a particular noise type 176 in the first training data 166a based on the score assigned to one or more performance metrics 170. The assumption here is that a particular noise pattern 168 that represents a particular noise type 176 causes one or more performance metrics 170 to achieve certain scores. For example, a noise pattern 168 that represents label noise may cause a score of the label consistency metric to be lower than a predefined threshold defined for the label consistency metric, thus indicating that the first training data 166a includes label noise. In another example, a noise pattern 168 that represents feature noise may cause a score of the feature correlation metric to equal or exceed a predefined threshold defined for the feature correlation metric, thus indicating that the first training data 166a includes label noise.

In operation, training manager 150 inputs the first training data 166a to the trained second AI model 160b and executes the second AI algorithm 164 associated with the second AI model 160b. Executing the second AI algorithm 164 causes the second AI model 160b to first analyze the first training data 166a and determine a plurality of performance metrics 170 based on the first training data 166a. As described above, determining the performance metrics 170 includes determining a score for each performance metric 170 of the plurality of performance metrics 170. Once the performance metrics 170 have been determined/obtained, the second AI model 160b attempts to map the determined performance metrics 170 and respective scores with known noise patterns 168 of various noise types 176 based on known associations between the performance metrics 170 and known noise patterns 168. For example, when a score of the label consistency metric is lower than a predefined threshold defined for the label consistency metric, the second AI model 160b determines that the first training data 166a includes label noise. In another example, when a score of the feature correlation metric equals or exceeds a predefined threshold defined for the feature correlation metric, the second AI model 160b determines that the first training data 166a includes feature noise.

In one or more embodiments, once it is determined that first training data 166a includes noise 174 of a particular noise type 176 (e.g., label noise, feature noise etc.), second AI model 160b may determine an appropriate noise mitigation algorithm 172 that can be used to mitigate (e.g., lower/remove) at least a portion of the detected noise 174 from the first training data 166a. In this context, the second AI algorithm 164 of the second AI model 160b may be trained based on a plurality of noise mitigation algorithms 172 that can be used to mitigate noise 174 of various noise types 176. For example, each particular noise type 176 may be mapped to one or more noise mitigation algorithms 172 that can be used to mitigate (e.g., lower/remove) noise 174 of the particular noise type 176 from data (e.g., training data 166). The second AI algorithm 164 of the second AI model 160b may be trained based on these mappings of noise types 176 and corresponding noise mitigation algorithms 172, to determine a particular noise mitigation algorithm 172 that can be used to mitigate (e.g., lower/remove) noise 174 of a particular noise type 176 from the first training data 166a.

For example, label noise may be mapped to label propagation algorithm which is a semi-supervised machine learning technique that leverages a small amount of labeled data to assign labels to unlabeled data. This algorithm starts with a small set of labeled examples (for which the correct labels are known) and propagates the labels from the small, labeled set to a larger unlabeled set, exploiting the assumption that similar data points typically share the same label.

In another example, feature noise may be mapped to a random forest algorithm which is well-suited to handle feature noise (e.g., irrelevant or redundant features) due to its inherent properties, including ensemble learning, bootstrapping (bagging), and random feature selection. The random forest algorithm mitigates feature noise through a combination of random feature selection, bootstrapping, and the ensemble approach of averaging or majority election. These mechanisms reduce the impact of noisy or irrelevant features, leading to more accurate and robust predictions. Additionally, by assessing feature importance, the algorithm can identify and remove noisy features to further improve model performance.

Thus, in one or more embodiments, once it is determined that first training data 166a includes noise 174 of a particular noise type 176 (e.g., label noise, feature noise etc.), second AI model 160b may identify a noise mitigation algorithm 172 that is mapped to the particular noise type 176. For example, the second AI model 160b may output the identified noise mitigation algorithm 172 as part of a result generated by the second AI model 160b in response to the first training data 166a input to the second AI model 160b. Training manager 150 may be configured run the identified noise mitigation algorithm 172 on the first training data 166a to mitigate the noise 174 of the particular noise type 176 detected in the first raining data 166a to generate first clean training data 173. First clean training data 173 refers to the first training data 166a after the noise mitigation algorithm 172 has been run to mitigate the detected noise 174. In other words, first clean training data 173 is a cleaned-up version of the first training data 166a. The training manager 150 may then train the first AI algorithm 162 of the first AI model 160a based on the first clean training data 173. By training the first AI algorithm 162 of the first AI model 160a based on the first clear training data 173 having less or no noise 174, the training manager 150 avoids the technical disadvantages associated with training the first AI algorithm 162 of the first AI model 160a based on noisy training data. This improves the quality (e.g., accuracy) of results generated by the first AI model 160a and thus improves the performance of the first AI model 160a and the underlying computing systems and networks.

In one or more embodiments, before training the first AI algorithm 162 of the first AI model 160a based on the first clean training data 173, the training manager 150 may be configured to run an overfitting algorithm on the first clean training data 173 to avoid or remove any overfitting issues associated with the first AI model 160a because of training based on the first clean training data 173. Overfitting occurs when an AI model (e.g., first AI model 160a) learns not only the underlying patterns in the training data but also the noise, outliers, or random fluctuations. As a result, the model becomes too complex and tightly aligned with the training data, which leads to poor generalization to new, unseen data. For example, even after running the first training data 166a through the noise mitigation algorithm 172, there may be some residual noise 180 leftover in the first clean training data 173. In this case, overfitting may include the first AI model 160a learning data patterns based on the residual noise 180 in the first clean training data 173. In one embodiment, the training manager 150 may use one or more overfitting algorithms 184 to mitigate (e.g., lower or remove) overfitting of the first AI model 160a. For example, the training manager 150 may use a regularization algorithm that avoids the first AI model 160a from deriving data patterns based on the residual noise 180 in the first clean training data 173.

In one or more embodiments, the training manager 150 may be configured to iteratively run the first training data 166a through the second AI model 160b until the noise 174 in the first training data 166a falls below a pre-configured noise threshold 182. Each iteration includes inputting the first training data 166a or the first clean training data 173 to the second AI model 160, obtaining as part of the result output by the second AI model 160 an indication that the first training data 166 or the first clean training data 173 includes noise 174 of a particular noise type 176 along with an identity of a noise mitigation algorithm 172, and running the first training data 166 or the first clean training data 173 through the identified noise mitigation algorithm 172 to generate another version of the first clean training data 173. For example, once a first iteration is completed as described above and a first version of the first clean training data 173 is generated, the training manager 150 determines whether the noise 174 in the first clean training data 173 has dropped below the noise threshold 182. When the noise 174 in the first clean training data 173 has not dropped below the noise threshold 182, the training manager 150 runs another iteration by inputting the first version of the first clean training data 173 to the second AI model 160b and runs the noise mitigation algorithm 172 identified in the second iteration to mitigate (e.g., lower/remove) any residual noise 180 in the first version of the first clean training data 173 to generate a second version of the first clean training data 173. The training manager 150 again determines whether the noise 174 in the second version of the first clean training data 173 has dropped below the noise threshold 182 and runs another iteration when the noise 174 still has not dropped below the noise threshold 182. The training manager 150 continues to run additional iterations of the process described above until the noise 174 in the latest version of the first clean training data 173 drops below the noise threshold 182.

In response to determining that the noise 174 in the latest version of the first clean training data 173 has dropped below the noise threshold 182, training manager 150 may be configured to train the first AI algorithm 162 of the first AI model 160a based on the latest version of the first clean training data 173. In one embodiment, the training manager 150 may be configured to run each version of the first clean training data 173 through the overfitting algorithm 184 before running the next iteration. In other words, the overfitting algorithm 184 is run as part of each iteration. In an alternative embodiment, the training manager 150 may be configured to only run the final version of the first clean training data 173 through the overfitting algorithm 184 after determining that noise 174 in the final version of the first clean training data 173 has dropped below the noise threshold 182.

FIG. 2 illustrates a flowchart of an example method 200 for detecting and mitigating noise 174 in training data 166, in accordance with certain embodiments of the present disclosure. Method 200 may be performed by the training manager 150 shown in FIG. 1.

At operation 202, training manager 150 receives first training data 166a to be used for training first AI algorithm 162 associated with first AI model 160a.

As described above, training manager 150 may be configured to proactively detect and mitigate noise 174 in training data 166 to be used to train an AI algorithm 162, 164 associated with an AI model 160. For example, training manager 150 may be configured to detect and mitigate noise 174 in first training data 166a that is to be used to train the first AI algorithm 162 of the first AI model 160a.

At operation 204, training manager 150 inputs the first training data 166a to second AI model 160b.

As described above, to detect noise 174 in the first training data 166a, the training manager 150 employs second AI model 160b that is trained to detect several types of noise 174 (e.g., noise types 176) in training data 166 used to train AI algorithms 162, 164 of AI models 160 and further to determine a noise mitigation algorithm 172 that can be used to mitigate the detected noise 174. In one or more embodiments, the second AI algorithm 164 of the second AI model 160b is trained based on known noise patterns 168 associated with several noise types 176 and corresponding performance metrics 170 known to be associated with the noise patterns 168, to detect whether first training data 166 includes noise 174 and further to determine what noise type 176 is included in the first training data 166.

For example, each known noise pattern 168 is a general pattern of noise data known to be associated with a particular noise type 176 and is identified by one or more performance metrics 170 associated with the training data 166 being analyzed by the second AI model 160b. A performance metric 170 indicates quality of the training data 166 based on which the performance metric 170 was determined. Several performance metrics 170 may be used to identify the type of noise (e.g., noise type 176) and amount of noise in training data 166, wherein the plurality of performance metrics 170 may include, but are not limited to, signal-to-noise ratio (SNR), mean absolute error (MAE), outlier detection metrics, noise-to-data ratio (NDR), class imbalance metrics, label consistency, entropy and variance, or feature correlation matrix.

At operation 206, training manager 150 executes a second AI algorithm 164 associated with the second AI model 160b to perform a plurality of operations 206A, 206B, 206C, and 206D to identify noise 174 of a particular noise type 176 in the first training data 166a.

At operation 206A, training manager 150 determines a plurality of performance metrics 170 associated with the first training data 166a.

At operation 206B, training manager 150 determines that one or more of the plurality of performance metrics 170 are associated with a first noise pattern (e.g., noise pattern 168).

At operation 206C, training manager 150 identifies a first type of noise (e.g., noise type 176) indicated by the first noise pattern (e.g., noise pattern 168).

At operation 206D, training manager 150 determines that the first training data 166a includes the first type of noise (e.g., noise type 176) mapped to the first noise pattern (e.g., noise pattern 168) identified in the first training data 166a.

As described above, executing the second AI algorithm 164 causes the second AI model 160b to first analyze the first training data 166a and determine a plurality of performance metrics 170 based on the first training data 166a. As described above, determining the performance metrics 170 includes determining a score for each performance metric 170 of the plurality of performance metrics 170. Once the performance metrics 170 have been determined/obtained, the second AI model 160b attempts to map the determined performance metrics 170 and respective scores with known noise patterns 168 of various noise types 176 based on known associations between the performance metrics 170 and known noise patterns 168. For example, when a score of the label consistency metric is lower than a predefined threshold defined for the label consistency metric, the second AI model 160b determines that the first training data 166a includes label noise. In another example, when a score of the feature correlation metric equals or exceeds a predefined threshold defined for the feature correlation metric, the second AI model 160b determines that the first training data 166a includes feature noise.

At operation 208, training manager 150 obtains (accesses from memory 156) a first noise mitigation algorithm 172 associated with the identified first type of noise (e.g., noise type 176) in the first training data 166a and that is configured to mitigate (e.g., lower/remove) the first type of noise.

As described above, once it is determined that first training data 166a includes noise 174 of a particular noise type 176 (e.g., label noise, feature noise etc.), second AI model 160b may determine an appropriate noise mitigation algorithm 172 that can be used to mitigate (e.g., lower/remove) at least a portion of the detected noise 174 from the first training data 166a. In this context, the second AI algorithm 164 of the second AI model 160b may be trained based on a plurality of noise mitigation algorithms 172 that can be used to mitigate noise 174 of various noise types 176. For example, each particular noise type 176 may be mapped to one or more noise mitigation algorithms 172 that can be used to mitigate (e.g., lower/remove) noise 174 of the particular noise type 176 from data (e.g., training data 166). The second AI algorithm 164 of the second AI model 160b may be trained based on these mappings of noise types 176 and corresponding noise mitigation algorithms 172, to determine a particular noise mitigation algorithm 172 that can be used to mitigate (e.g., lower/remove) noise 174 of a particular noise type 176 from the first training data 166a.

For example, label noise may be mapped to label propagation algorithm which is a semi-supervised machine learning technique that leverages a small amount of labeled data to assign labels to unlabeled data. This algorithm starts with a small set of labeled examples (for which the correct labels are known) and propagates the labels from the small, labeled set to a larger unlabeled set, exploiting the assumption that similar data points typically share the same label.

In another example, feature noise may be mapped to a random forest algorithm which is well-suited to handle feature noise (e.g., irrelevant or redundant features) due to its inherent properties, including ensemble learning, bootstrapping (bagging), and random feature selection. The random forest algorithm mitigates feature noise through a combination of random feature selection, bootstrapping, and the ensemble approach of averaging or majority election. These mechanisms reduce the impact of noisy or irrelevant features, leading to more accurate and robust predictions. Additionally, by assessing feature importance, the algorithm can identify and remove noisy features to further improve model performance.

Thus, in one or more embodiments, once it is determined that first training data 166a includes noise 174 of a particular noise type 176 (e.g., label noise, feature noise etc.), second AI model 160b may identify a noise mitigation algorithm 172 that is mapped to the particular noise type 176. For example, the second AI model 160b may output the identified noise mitigation algorithm 172 as part of a result generated by the second AI model 160b in response to the first training data 166a input to the second AI model 160b.

At operation 210, training manager 150 runs the first noise mitigation algorithm 172 to mitigate (e.g., lower/remove) the identified first type of noise relating to the first training data 166a to generate first clean training data 173.

As described above, training manager 150 may be configured run the identified noise mitigation algorithm 172 on the first training data 166a to mitigate the noise 174 of the particular noise type 176 detected in the first raining data 166a to generate first clean training data 173. First clean training data 173 refers to the first training data 166a after the noise mitigation algorithm 172 has been run to mitigate the detected noise 174. In other words, first clean training data 173 is a cleaned-up version of the first training data 166a. The training manager 150 may then train the first AI algorithm 162 of the first AI model 160a based on the first clean training data 173. By training the first AI algorithm 162 of the first AI model 160 based on the first clear training data 173 having less or no noise 174, the training manager 150 avoids the technical disadvantages associated with training the first AI algorithm 162 of the first AI model 160a based on noisy training data. This improves the quality (e.g., accuracy) of results generated by the first AI model 160a and thus improves the performance of the first AI model 160a and the underlying computing systems and networks.

At operation 212, training manager 150 checks whether noise 174 of the identified noise type 176 is lower than a pre-configured noise threshold 182. When the noise 174 of the identified noise type 176 is not lower than the pre-configured noise threshold 182, method 200 proceeds back to operation 204 to run a second iteration of the above process to remove any residual noise 180 in the first training data 166a. On the other hand, when the noise 174 of the identified noise type 176 is found to be lower than the pre-configured noise threshold 182, method 200 proceeds to operation 214 where training manager trains the first AI algorithm 162 of the first AI model 160a based on the first clean training data 173 (e.g., the latest version of the first clean training data 173 generated as part of the latest iteration of the above process).

As described above, training manager 150 may be configured to iteratively run the first training data 166a through the second AI model 160b until the noise 174 in the first training data 166a falls below a pre-configured noise threshold 182. Each iteration includes inputting the first training data 166a or the first clean training data 173 to the second AI algorithm 164 of the second AI model 160, obtaining as part of the result output by the second AI model 160 an indication that the first training data 166 or the first clean training data 173 includes noise 174 of a particular noise type 176 along with an identity of a noise mitigation algorithm 172, and running the first training data 166 or the first clean training data 173 through the identified noise mitigation algorithm 172 to generate another version of the first clean training data 173. For example, once a first iteration is completed as described above and a first version of the first clean training data 173 is generated, the training manager 150 determines whether the noise 174 in the first clean training data 173 has dropped below the noise threshold 182. When the noise 174 in the first clean training data 173 has not dropped below the noise threshold 182, the training manager 150 runs another iteration by inputting the first version of the first clean training data 173 to the second AI model 160b and runs the noise mitigation algorithm 172 identified in the second iteration to mitigate (e.g., lower/remove) any residual noise 180 in the first version of the first clean training data 173 to generate a second version of the first clean training data 173. The training manager 150 again determines whether the noise 174 in the second version of the first clean training data 173 has dropped below the noise threshold 182 and runs another iteration when the noise 174 still has not dropped below the noise threshold 182. The training manager 150 continues to run additional iterations of the process described above until the noise 174 in the latest version of the first clean training data 173 drops below the noise threshold 182.

In response to determining that the noise 174 in the latest version of the first clean training data 173 has dropped below the noise threshold 182, training manager 150 may be configured to train the first AI algorithm 162 of the first AI model 160a based on the latest version of the first clean training data 173. In one embodiment, the training manager 150 may be configured to run each version of the first clean training data 173 through the overfitting algorithm 184 before running the next iteration. In other words, the overfitting algorithm 184 is run as part of each iteration. In an alternative embodiment, the training manager 150 may be configured to only run the final version of the first clean training data 173 through the overfitting algorithm 184 after determining that noise 174 in the final version of the first clean training data 173 has dropped below the noise threshold 182.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a memory storing:
a first artificial intelligence model; and
a noise mitigation algorithm associated with each type of noise known to be included in training data used for training a first artificial intelligence algorithm associated with the first artificial intelligence model; and
a processor communicatively coupled to the memory and configured to:
receive first training data to be used for training the first artificial intelligence algorithm associated with the first artificial intelligence model;
input the first training data to a second artificial intelligence model, wherein:
a second artificial intelligence algorithm associated with the second artificial intelligence model is trained based on known noise patterns associated with the training data and one or more performance metrics known to be associated with each of the known noise patterns, to determine a type of noise included in the first training data that is to be used to train the first artificial intelligence algorithm associated with the first artificial intelligence model;
each performance metric indicates quality of the training data;
each known noise pattern corresponds to a particular type of noise relating to the training data; and
the noise comprises anomalies in the training data that can cause the first artificial intelligence model to generate erroneous results;
execute the second artificial intelligence algorithm associated with the second artificial intelligence model to:
determine a plurality of the performance metrics associated with the first training data;
determine that one or more of the plurality of performance metrics are associated with a first noise pattern;
identify a first type of noise indicated by the first noise pattern; and
determine that the first training data comprises the first type of noise;
access from the memory, a first noise mitigation algorithm associated with the first type of noise and configured to mitigate the first type of noise relating to the first training data;
run the first noise mitigation algorithm to mitigate the first type of noise relating to the first training data to generate first clean training data; and
train the first artificial intelligence algorithm associated with the first artificial intelligence model based on the first clean training data.

2. The system of claim 1, wherein the processor is further configured to:
execute the second artificial intelligence algorithm associated with the second artificial intelligence model to:
determine the one or more performance metrics associated with the first clean training data;
determine, based on the one or more performance metrics associated with the first clean training data, that the first clean training data comprises residual first type of noise, wherein the residual first type of noise comprises the first type of noise remaining in the first training data after running the first noise mitigation algorithm;
access from the memory, the first noise mitigation algorithm associated with the first type of noise and configured to mitigate the first type of noise relating to the training data; and
run the first noise mitigation algorithm to mitigate the residual first type of noise relating to the first clean training data to generate a second clean training data; and
train the first artificial intelligence algorithm associated with the first artificial intelligence model based on the second clean training data.

3. The system of claim 1, wherein the processor is further configured to:
execute the second artificial intelligence algorithm associated with the second artificial intelligence model to iteratively run the first noise mitigation algorithm to mitigate residual first type of noise relating to the first training data until the first type of noise is lower than a pre-configured threshold, wherein the residual first type of noise comprises the first type of noise remaining in the first training data after running the first noise mitigation algorithm.

4. The system of claim 1, wherein the performance metrics comprises one or more of signal-to-noise ratio (SNR), mean absolute error (MAE), outlier detection metrics, noise-to-data ratio (NDR), class imbalance metrics, label consistency, entropy and variance metrics, or feature correlation matrix.

5. The system of claim 1, wherein the processor is further configured to:
execute the second artificial intelligence algorithm associated with the second artificial intelligence model to:
run a regularization algorithm that mitigates the first artificial intelligence model from overfitting the first clean training data, wherein:
the overfitting comprises the first artificial intelligence model learning data patterns based on residual first type of noise in the first clean training data; and
the regularization algorithm avoids the first artificial intelligence model from deriving the data patterns based on the residual first type of noise in the first clean training data.

6. The system of claim 1, wherein:
the first type of noise comprises feature noise comprising one or more of irrelevant, incorrect or misleading information in one or more features of the first training data.

7. The system of claim 6 wherein:
the first algorithm used to mitigate the feature noise comprises a random forest algorithm.

8. A method comprising:
receiving first training data to be used for training a first artificial intelligence algorithm associated with a first artificial intelligence model;
inputting the first training data to a second artificial intelligence model, wherein:
a second artificial intelligence algorithm associated with the second artificial intelligence model is trained based on known noise patterns associated with the training data and one or more performance metrics known to be associated with each of the known noise patterns, to determine a type of noise included in the first training data that is to be used to train the first artificial intelligence algorithm associated with the first artificial intelligence model;
each performance metric indicates quality of the training data;
each known noise pattern corresponds to a particular type of noise relating to the training data; and
the noise comprises anomalies in the training data that can cause the first artificial intelligence model to generate erroneous results;
executing the second artificial intelligence algorithm associated with the second artificial intelligence model to:
determine a plurality of the performance metrics associated with the first training data;
determine that one or more of the plurality of performance metrics are associated with a first noise pattern;
identify a first type of noise indicated by the first noise pattern; and
determine that the first training data comprises the first type of noise;
accessing from a memory, a first noise mitigation algorithm associated with the first type of noise and configured to mitigate the first type of noise relating to the first training data;
running the first noise mitigation algorithm to mitigate the first type of noise relating to the first training data to generate first clean training data; and
training the first artificial intelligence algorithm associated with the first artificial intelligence model based on the first clean training data.

9. The method of claim 8, further comprising:
executing the second artificial intelligence algorithm associated with the second artificial intelligence model to:
determine the one or more performance metrics associated with the first clean training data;
determine, based on the one or more performance metrics associated with the first clean training data, that the first clean training data comprises residual first type of noise, wherein the residual first type of noise comprises the first type of noise remaining in the first training data after running the first noise mitigation algorithm;
access from the memory, the first noise mitigation algorithm associated with the first type of noise and configured to mitigate the first type of noise relating to the training data; and
run the first noise mitigation algorithm to mitigate the residual first type of noise relating to the first clean training data to generate a second clean training data; and
train the first artificial intelligence algorithm associated with the first artificial intelligence model based on the second clean training data.

10. The method of claim 8, further comprising:
executing the second artificial intelligence algorithm associated with the second artificial intelligence model to iteratively run the first noise mitigation algorithm to mitigate residual first type of noise relating to the first training data until the first type of noise is lower than a pre-configured threshold, wherein the residual first type of noise comprises the first type of noise remaining in the first training data after running the first noise mitigation algorithm.

11. The method of claim 8, wherein the performance metrics comprises one or more of signal-to-noise ratio (SNR), mean absolute error (MAE), outlier detection metrics, noise-to-data ratio (NDR), class imbalance metrics, label consistency, entropy and variance metrics, or feature correlation matrix.

12. The method of claim 8, further comprising:
executing the second artificial intelligence algorithm associated with the second artificial intelligence model to:
run a regularization algorithm that mitigates the first artificial intelligence model from overfitting the first clean training data, wherein:
the overfitting comprises the first artificial intelligence model learning data patterns based on residual first type of noise in the first clean training data; and
the regularization algorithm avoids the first artificial intelligence model from deriving the data patterns based on the residual first type of noise in the first clean training data.

13. The method of claim 8, wherein:
the first type of noise comprises feature noise comprising one or more of irrelevant, incorrect or misleading information in one or more features of the first training data.

14. The method of claim 13 wherein:
the first algorithm used to mitigate the feature noise comprises a random forest algorithm.

15. A non-transitory computer-readable medium storing instructions that when executed by a processor causes the processor to:
receive first training data to be used for training a first artificial intelligence algorithm associated with a first artificial intelligence model;
input the first training data to a second artificial intelligence model, wherein:
a second artificial intelligence algorithm associated with the second artificial intelligence model is trained based on known noise patterns associated with the training data and one or more performance metrics known to be associated with each of the known noise patterns, to determine a type of noise included in the first training data that is to be used to train the first artificial intelligence algorithm associated with the first artificial intelligence model;
each performance metric indicates quality of the training data;
each known noise pattern corresponds to a particular type of noise relating to the training data; and
the noise comprises anomalies in the training data that can cause the first artificial intelligence model to generate erroneous results;
execute the second artificial intelligence algorithm associated with the second artificial intelligence model to:
determine a plurality of the performance metrics associated with the first training data;
determine that one or more of the plurality of performance metrics are associated with a first noise pattern;
identify a first type of noise indicated by the first noise pattern; and
determine that the first training data comprises the first type of noise;
access from a memory, a first noise mitigation algorithm associated with the first type of noise and configured to mitigate the first type of noise relating to the first training data;
run the first noise mitigation algorithm to mitigate the first type of noise relating to the first training data to generate first clean training data; and
train the first artificial intelligence algorithm associated with the first artificial intelligence model based on the first clean training data.

16. The non-transitory computer-readable medium of claim 15, wherein the instructions further cause the processor to:
execute the second artificial intelligence algorithm associated with the second artificial intelligence model to:
determine the one or more performance metrics associated with the first clean training data;
determine, based on the one or more performance metrics associated with the first clean training data, that the first clean training data comprises residual first type of noise, wherein the residual first type of noise comprises the first type of noise remaining in the first training data after running the first noise mitigation algorithm;
access from the memory, the first noise mitigation algorithm associated with the first type of noise and configured to mitigate the first type of noise relating to the training data; and
run the first noise mitigation algorithm to mitigate the residual first type of noise relating to the first clean training data to generate a second clean training data; and
train the first artificial intelligence algorithm associated with the first artificial intelligence model based on the second clean training data.

17. The non-transitory computer-readable medium of claim 15, wherein the instructions further cause the processor to:
Execute the second artificial intelligence algorithm associated with the second artificial intelligence model to iteratively run the first noise mitigation algorithm to mitigate residual first type of noise relating to the first training data until the first type of noise is lower than a pre-configured threshold, wherein the residual first type of noise comprises the first type of noise remaining in the first training data after running the first noise mitigation algorithm.

18. The non-transitory computer-readable medium of claim 15, wherein the performance metrics comprises one or more of signal-to-noise ratio (SNR), mean absolute error (MAE), outlier detection metrics, noise-to-data ratio (NDR), class imbalance metrics, label consistency, entropy and variance metrics, or feature correlation matrix.

19. The non-transitory computer-readable medium of claim 15, wherein the instructions further cause the processor to:
Execute the second artificial intelligence algorithm associated with the second artificial intelligence model to:
run a regularization algorithm that mitigates the first artificial intelligence model from overfitting the first clean training data, wherein:
the overfitting comprises the first artificial intelligence model learning data patterns based on residual first type of noise in the first clean training data; and
the regularization algorithm avoids the first artificial intelligence model from deriving the data patterns based on the residual first type of noise in the first clean training data.

20. The non-transitory computer-readable medium of claim 15, wherein:
the first type of noise comprises feature noise comprising one or more of irrelevant, incorrect or misleading information in one or more features of the first training data.
